(19) United States
(12) Patent Application Publication
(10) Pub. No.: US 2011/0038335 A1
(43) Pub. Date: Feb. 17, 2011

(54) METHOD AND APPARATUS FOR MULTIPLEXING DATA

(75) Inventors: Kyung Sook KIM, Daejeon (KR); Jaesheung SHIN, Daejeon (KR); Hyun Seo PARK, Daejeon (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/856,060

(22) Filed: Aug. 13, 2010

(30) Foreign Application Priority Data
Aug. 14, 2009 (KR) 10-2009-0075418
Jul. 23, 2010 (KR) 10-2010-0071586

(51) Int. Cl. H04W 4/00

(52) U.S. Cl. 370/329

(57) ABSTRACT

A method of multiplexing data of a terminal is provided. The method comprises receiving uplink resource allocation information about a service specific identifier for a specific service and information for the specific service comprising a radio bearer (RB) list to be transmitted through resources that are allocated according to the uplink resource allocation information from a base station and multiplexing data of the RB list to the allocated resources.

### CROSS-REFERENCE TO RELATED APPLICATION

This application claims priority to and the benefit of Korean Patent Application Nos. 10-2009-0075418 and 10-2010-0071586 filed in the Korean Intellectual Property Office on Aug. 14, 2009 and Jul. 23, 2010, the entire contents of which are incorporated herein by reference.

### BACKGROUND OF THE INVENTION

(a) Field of the Invention

The present invention relates to a method and apparatus for multiplexing data. More particularly, the present invention relates to a method and apparatus in which a terminal that supports bandwidth extension multiplexes data.

(b) Description of the Related Art

A terminal can multiplex data through a logical channel prioritization procedure. That is, the terminal multiplexes new transmission data based on a priority of each logical channel that is set in a radio resource control (RRC) hierarchy, a prioritised bit rate (PBR), and a bucket size duration (BSD). When multiplexing, the terminal allocates a resource (hereinafter referred to as a “UL grant resource”) that is allocated according to uplink resource allocation information by a PBR/MCS based on an order of logical channels having a high priority. For example, a descending order of a priority of a logical channel is \textcircled{1} a medium access control (MAC) control element for a cell-radio network temporary identifier (C-RNTI) or data from an uplink common control channel (UL-CCCH), \textcircled{2} a MAC control element for a buffer status report (BSR), except for a BSR included for padding, \textcircled{3} a MAC control element for a power headroom report (PHR), \textcircled{4} data from a logical channel, except for data from the UL-CCCH, and \textcircled{5} a MAC control element for a BSR included for padding. That is, the terminal multiplexes new transmission data based on the descending order of the priority of the logical channel. The terminal terminates multiplexing when the UL grant resource is exhausted or when the logical channel having data to transmit no longer exists.

Here, the terminal can provide a specific service. An example of the specific service is a voice over Internet protocol (VoIP) service according to semi persistent scheduling (SPS). In order for the terminal to use a specific service, a base station sets a service specific C-RNTI for transmitting specific service data to the terminal, and additionally allocates a UL grant resource for the service specific C-RNTI other than a UL grant resource for a C-RNTI. When the specific service is a service according to the SPS, the service specific C-RNTI may be referred to as an SPS C-RNTI. The terminal multiplexes data to the UL grant resource that is allocated from the base station and transmits data to an uplink.

In order to improve a transmission rate of a wireless communication system, a bandwidth extension has been discussed. When the wireless communication system supports the bandwidth extension, the terminal can simultaneously perform uplink transmission or downlink reception through a plurality of component carriers (CC). Accordingly, the terminal can receive uplink resource allocation information intended for a C-RNTI through one of a plurality of CCs and receive uplink resource allocation information intended for a service specific C-RNTI through another CC within the same subframe.

When the terminal performs multiplexing of data according to a logical channel prioritization procedure, if data of a specific service to be newly transmitted exists in a buffer of the terminal and a priority of a corresponding logical channel is high, the data of the specific service can be multiplexed to a UL grant resource for a C-RNTI according to the priority of the logical channel. Accordingly, a problem that a UL grant resource for a service specific C-RNTI is wasted may occur.

Further, when data to be transmitted exists in a logical channel having higher priority than a logical channel of a specific service, data other than data of the specific service can be multiplexed to a UL grant resource for the service specific C-RNTI. In this case, unnecessary segmentation of data can occur, and data may not be transmitted at a time point at which data of the specific service should be transmitted. Accordingly, when the specific service is a VoIP service to be periodically transmitted, a quality of the service is deteriorated. A problem that a resource release procedure for a service specific C-RNTI is not appropriately performed may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for multiplexing data having advantages of effectively using a radio resource.

An exemplary embodiment of the present invention provides a method of multiplexing data of a terminal, the method including: receiving uplink resource allocation information intended for a service specific C-RNTI for a specific service and information for the specific service comprising a radio bearer (RB) list to be transmitted through resources that are allocated according to the uplink resource allocation information from a base station and multiplexing data of the RB list to the allocated resources.

Another embodiment of the present invention provides a method of allocating a resource of a base station, the method including: setting uplink resource allocation information intended for a service specific C-RNTI for a specific service and information for the specific service comprising an RB list to be transmitted through resources that are allocated for the service specific C-RNTI and transmitting the information for the specific service to a terminal.

Yet another embodiment of the present invention provides a terminal including: a wireless communication unit that receives uplink resource allocation information about a service specific C-RNTI for a specific service and information for the specific service comprising an RB list to be transmitted through resources that are allocated according to the uplink resource allocation information from a base station, and that transmits multiplexed data to the base station and a controller that multiplexes data of the RB list to the allocated resources.

### BRIEF DESCRIPTION OF THE DRAWINGS

FIG. 1 is a diagram illustrating an example in which a terminal transmits a VoIP service with an uplink.

FIG. 2 is a diagram illustrating an example of data transmission of a terminal when the terminal receives allocation of a UL grant for a C-RNTI and a UL grant for a service specific C-RNTI.

FIG. 3 is a flowchart illustrating a method of multiplexing data of a terminal when transmitting a specific service data according to an exemplary embodiment of the present invention.

FIG. 4 is a block diagram illustrating a configuration of a terminal according to an exemplary embodiment of the present invention, and FIG. 5 is a flowchart illustrating a method of multiplexing data of a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

In this specification, a terminal may indicate a mobile station (MS), a mobile terminal (MT), a subscriber station (SS), a portable subscriber station (PSS), user equipment (UE), and an access terminal (AT), and may include an entire function or a partial function of the MS, the MT, the SS, the PSS, the UE, and the AT.

In this specification, a base station (BS) may indicate a radio access station (RAS), a node B, an evolved nodeB (eNodeB), a base transceiver station (BTS), and a mobile multihop relay (MMR)-BS, and may include an entire function or a partial function of the RAS, the node B, the eNodeB, the BTS, and the MMR-BS.

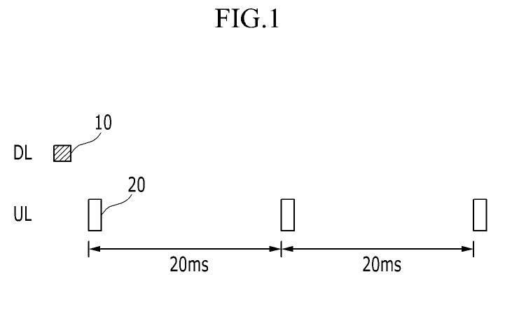

FIG. 1 is a diagram illustrating an example in which a terminal transmits a voice over Internet protocol (VoIP) service with an uplink. The VoIP service is an example of a specific service, and served by semi-persistent scheduling (SPS).

Referring to FIG. 1, the terminal sets a service specific cell radio network temporary identifier (C-RNTI) for a specific service, for example a VoIP service and a transmission period of the VoIP service by a radio resource control (RRC) layer. Here, the C-RNTI is an identifier for identifying a connection of a terminal within a cell area, and the service specific C-RNTI is a C-RNTI of a specific service.

When the terminal receives uplink resource allocation information (hereinafter referred to as a “UL grant”) 10 for the service specific C-RNTI from the base station, the terminal multiplexes and transmits data 20 on an uplink resource (hereinafter referred to as a “UL grant resource”) that is allocated by the UL grant on every transmission period of the VoIP service. Therefore, the terminal can periodically transmit a VoIP service via an uplink without receiving uplink resource allocation information through a physical downlink control channel (PDCCH) on every transmission period of the VoIP service.

If data in which the terminal transmits through a UL grant resource for a service specific C-RNTI do not exist for two transmissions or three transmissions, a release procedure of the UL grant resource for the service specific C-RNTI can be performed. The release procedure of the UL grant resource for the service specific C-RNTI can be configured by a RRC layer.

When a mobile communication system supports a bandwidth extension, the terminal may receive uplink resource allocation information (e.g., a UL grant) intended for a C-RNTI through one of a plurality of component carriers (CC), and receive uplink resource allocation information intended for a service specific C-RNTI through another CC within the same subframe.

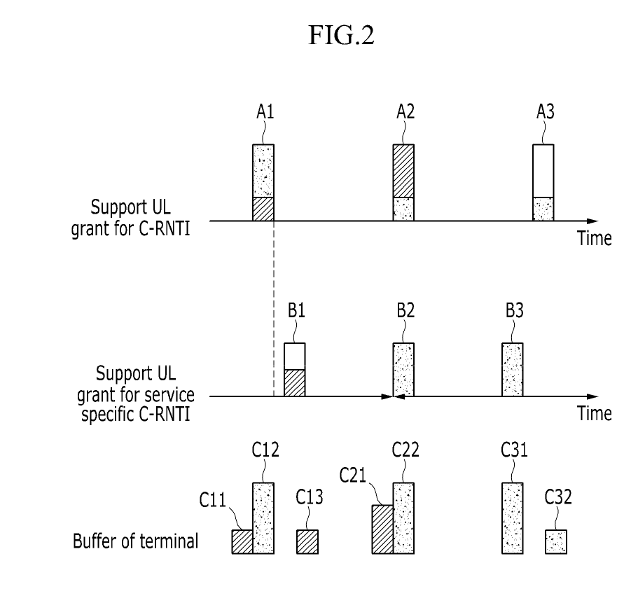

FIG. 2 is a diagram illustrating an example of data transmission of a terminal when the terminal receives allocation of a UL grant resource for a C-RNTI and a UL grant resource for a service specific C-RNTI.

Referring to FIG. 2, data of a radio bearer (RB) for a specific service and data of RBs other than the RB for the specific service exist together in uplink buffers of the terminal, and the terminal can receive allocation of a UL grant resource A1 for a C-RNTI and a UL grant resource B1 for a service specific C-RNTI from a base station. In this case, when data C11 of an RB (hereinafter referred to as a “specific service RB”) for a specific service and data C12 of RBs (hereinafter referred to as a “general RB”) other than the specific service RB are multiplexed to the UL grant resource A1 for the C-RNTI, the UL grant resource B1 that is semi-persistently allocated for the service specific C-RNTI may be wasted. Data C11 and C13 of the specific service RB may be unnecessarily segmented according to a size of the UL grant resource.

Alternatively, data C21 of the specific service RB and data C22 of the general RB exist together in uplink buffers of the terminal, and the terminal can receive allocation of a UL grant resource A2 for the C-RNTI and a UL grant resource B2 for the service specific C-RNTI in the same subframe from the base station. In this case, when data C21 of the specific service RB having a high priority are firstly multiplexed by a logical channel prioritization procedure to the UL grant resource A2 for the C-RNTI and data C22 of the general RB are multiplexed to the remaining UL grant resource A2 for the C-RNTI, the data C22 of the general RB may be unnecessarily segmented.

Otherwise, data C31 and C32 of the general RB exist in the uplink buffers of the terminal, and the terminal can receive allocation of a UL grant resource B3 for the service specific C-RNTI and a UL grant resource A3 for the C-RNTI from the base station. In this case, the data C31 of the general RB can be multiplexed to the UL grant resource B3 for the service specific C-RNTI. Accordingly, the UL grant resource A3 for the C-RNTI that is dynamically allocated by the base station may be wasted according to a uplink buffer size of the terminal.

Therefore, a multiplexing method for preventing resource waste and unnecessary segmentation of data is necessary.

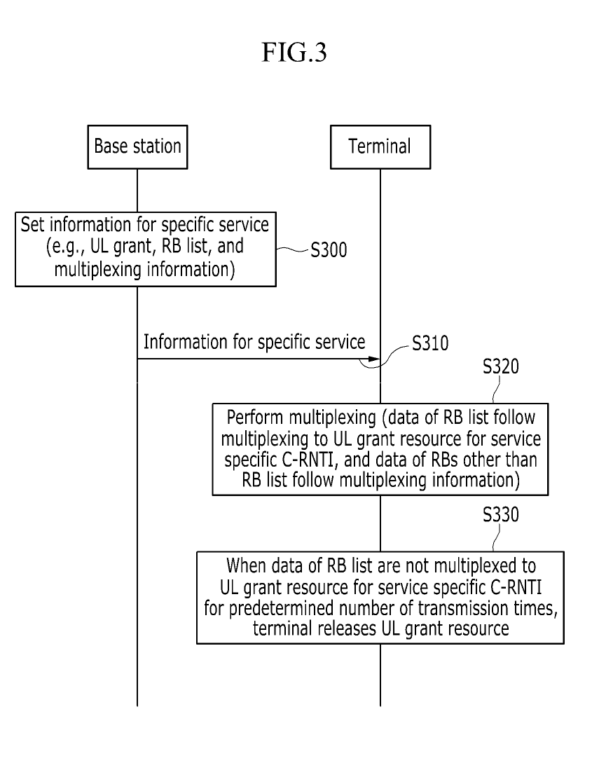

FIG. 3 is a flowchart illustrating a method of multiplexing data of a terminal when transmitting a specific service according to an exemplary embodiment of the present invention. An example of a specific service may be a VoIP service, which is served by semi-persistent scheduling.

Referring to FIG. 3, a base station sets information for transmitting a specific service (S300). The information for transmitting a specific service may include a service specific C-RNTI identifier, UL grant allocation information for transmitting specific service data, an RB list to be transmitted through a UL grant resource for the service specific C-RNTI, and multiplexing information about the UL grant resource for the service specific C-RNTI. The RB list may include at least one RB identifier. The multiplexing information is information about whether multiplexing of RBs (hereinafter referred to as “RBs other than an RB list”) other than an RB list that is transmitted through the UL grant resource for the service specific C-RNTI is allowed. The information about whether multiplexing of RBs other than an RB list is allowed has one value of true and false, and one of true and false can be set as a default value.

The base station transmits configuration information for the specific service to the terminal (S310). When the specific service is an SPS service, configuration information for the specific service can be transmitted in a form of a configuration message before the specific service is started. While the specific service is performed, even when configuration information is changed, the configuration information can be transmitted.

The terminal performs multiplexing based on configuration for transmitting the specific service that is received from the base station (S320). Data of an RB that is included in an RB list that is transmitted through the UL grant resource for the service specific C-RNTI are multiplexed to the UL grant resource for the service specific C-RNTI. That is, data of RBs that are included in an RB list are not multiplexed to a resource (e.g., a UL grant resource for a C-RNTI) that is not allocated for the service specific C-RNTI regardless of a priority. If information about whether multiplexing is allowed has a value of true, data of RBs other than an RB list are multiplexed to the UL grant resource for the service specific C-RNTI according to the priority. If information about whether multiplexing is allowed has a value of false, data of RBs other than an RB list are not multiplexed to the UL grant resource for the service specific C-RNTI.

If data of an RB list are not multiplexed to the UL grant resource for the service specific C-RNTI for the configured number of transmission times, the terminal releases the UL grant resource for the service specific C-RNTI (S330). In this case, the number of transmission times may be based on implicitly release configuration by an RRC layer. The release configuration may be, for example, implicitReleaseAfter. Therefore, when data of an RB list do not exist and data of RBs other than the RB list exist, even if data of RBs other than the RB list are multiplexed to the UL grant resource for the service specific C-RNTI the configured number of times, the terminal releases the UL grant resource for the service specific C-RNTI.

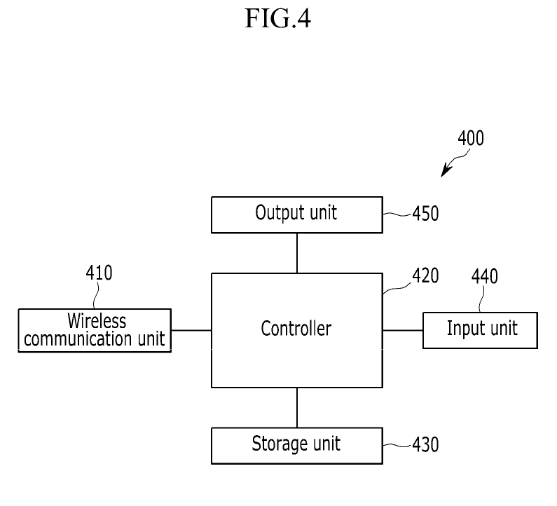

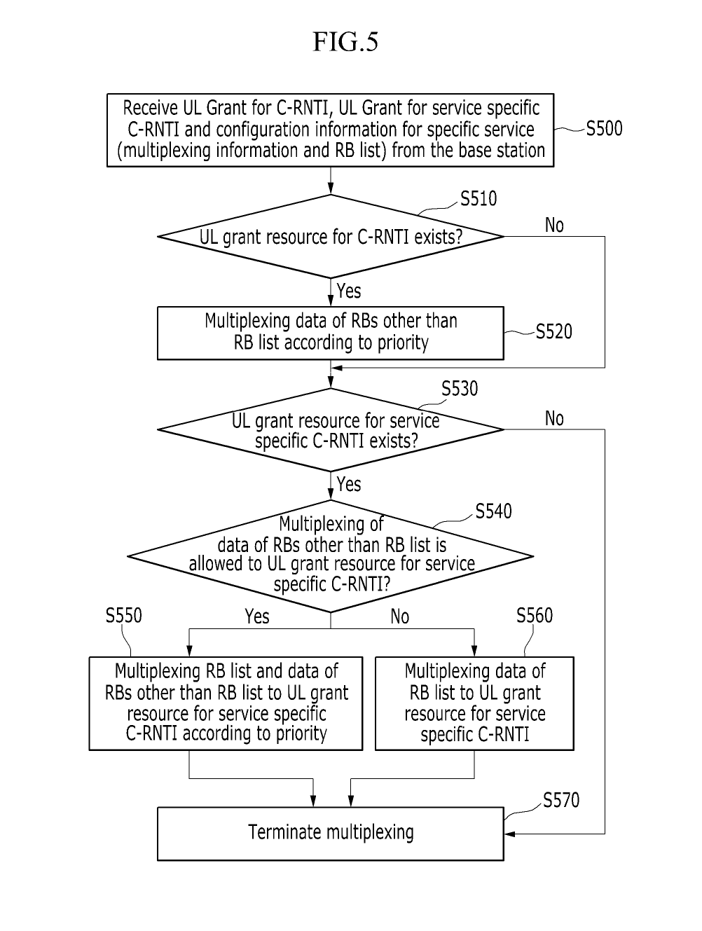

FIG. 4 is a block diagram illustrating a configuration of a terminal according to an exemplary embodiment of the present invention, and FIG. 5 is a flowchart illustrating a method of multiplexing a terminal according to an exemplary embodiment of the present invention.

Referring to FIG. 4, a terminal 400 includes a wireless communication unit 410, a controller 420, a storage unit 430, an input unit 440, and an output unit 450.

The wireless communication unit 410 performs a wireless communication function of the terminal 400. The wireless communication unit 410 includes a radio frequency (RF) unit that transmits/receives an RF signal.

The controller 420 controls general operations of the terminal 400. The controller 420 includes a data processor that encodes or modulates a signal to be transmitted or that demodulates and decodes a received signal.

The storage unit 430 stores a program for operating the controller 420 and input/output data.

The input unit 440 is used for inputting data or information for controlling operation of a terminal by a user.

The output unit 450 displays information that is processed in the terminal 400 to the user with various forms of signals (e.g., a sound signal and a visual signal).

Referring to FIGS. 4 and 5, the wireless communication unit 410 of the terminal 400 receives a UL grant for a C-RNTI, a UL grant for a service specific C-RNTI, and configuration information for a specific service including an RB list to be transmitted through a UL grant resource for the service specific C-RNTI from a base station (S500). The configuration information for the specific service may further include information about whether data of RBs other than an RB list is able to multiplexed to the UL grant resource for the service specific C-RNTI. When the terminal supports a bandwidth extension, the terminal can receive the UL grant for the C-RNTI through one of a plurality of component carriers (CC) and receive a UL grant for a service specific C-RNTI through another CC within the same subframe.

The controller 420 of the terminal 400 determines whether the UL grant resource for the C-RNTI exists in the corresponding subframe (S510). If the UL grant resource for the C-RNTI exists, RBs having data to be transmitted are multiplexed according to a priority (S520). Here, the RBs are RBs other than an RB list to be transmitted through the UL grant resource for the service specific C-RNTI.

When multiplexing is performed to the UL grant resource for the C-RNTI, or if the UL grant resource for the C-RNTI does not exist, the controller 420 of the terminal 400 determines whether the UL grant resource of the service specific C-RNTI exists in the corresponding subframe (S530). If the UL grant resource for the service specific C-RNTI exists in the corresponding subframe, the controller 420 of the terminal 400 determines whether multiplexing of data of RBs other than an RB list is allowed on the UL grant resource for the service specific C-RNTI (S540).

If multiplexing of data of RBs other than an RB list is allowed on the UL grant resource for the service specific C-RNTI, the controller 420 of the terminal 400 performs multiplexing of the RB list having data to be transmitted and RBs having data to be transmitted other than the RB list to the UL grant resource for the service specific C-RNTI according to a priority (S550).

If multiplexing of data of RBs other than the RB list is not allowed on the UL grant resource for the service specific C-RNTI, the controller 420 of the terminal 400 performs multiplexing of the RB list having data to be transmitted to the UL grant resource for the service specific C-RNTI according to a priority (S560).

If multiplexing is performed at step S550 or S560, or if the UL grant resource for the service specific C-RNTI does not exist at step S530, the controller 420 of the terminal 400 terminates a multiplexing procedure (S570).

In this way, when the base station notifies the terminal of configuration information for a specific service including an RB list to be transmitted through a UL grant resource for the service specific C-RNTI and whether data of RBs other than the RB list are multiplexed to the UL grant resource for the service specific C-RNTI, the terminal can perform multiplexing by effectively using the resource.

Accordingly, a method and apparatus for multiplexing data that can effectively use a radio resource are provided. Particularly, data can be multiplexed without wasting resources that are allocated for a specific service, and the resources that are allocated for the specific service can be released at an appropriate time.

The foregoing exemplary embodiment of the present invention may not only be embodied through an apparatus and a method but may also be embodied through a program that realizes a function corresponding to a configuration of the exemplary embodiment of the present invention or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of multiplexing data of a terminal, the method comprising:
receiving uplink resource allocation information intended for a service specific identifier for a specific service and configuration information for the specific service comprising a radio bearer (RB) list to be transmitted through resources that are allocated according to the uplink resource allocation information from a base station; and
multiplexing data of the RB list to the allocated resources.

2. The method of claim 1, wherein the information for the specific service further comprises information representing whether data of RBs other than the RB list is able to be multiplexed to the allocated resources.

3. The method of claim 2, wherein the multiplexing of data of the RB list comprises:
multiplexing, if multiplexing of the data of RBs other than the RB list is allowed, the data of the RB list and the data of the RBs other than the RB list to the allocated resources according to a priority; and
multiplexing, if multiplexing of the data of RBs other than the RB list is not allowed, data of the RB list to the allocated resources according to a priority.

4. The method of claim 3, further comprising releasing the allocated resources if the data of the RB list are not multiplexed to the allocated resources the number of predetermined transmission times.

5. The method of claim 4, wherein the predetermined number of transmission times is set for the terminal through an RRC configuration message.

6. The method of claim 1, wherein the specific service is served by a semi-persistent scheduling (SPS).

7. The method of claim 1, wherein the identifier is a cell radio network temporary identifier (C-RNTI).

8. The method of claim 1, further comprising:
receiving uplink resource allocation information intended for C-RNTI from the base station; and
multiplexing data of RBs other than the RB list to resources that are allocated for a C-RNTI according to a priority.

9. The method of claim 8, wherein uplink resource allocation for the C-RNTI is dynamically allocated according to a data amount existing in a uplink buffer of the terminal.

10. The method of claim 8, wherein the terminal supports bandwidth extension, receives the uplink resource allocation information intended for the C-RNTI through one of a plurality of component carriers, and receives the uplink resource allocation information intended for the service specific C-RNTI through one of the remaining component carriers within the same subframe.

11. A method of allocating a resource of a base station, the method comprising:
setting uplink resource allocation information intended for a service specific identifier for a specific service and configuration information for the specific service comprising an RB list to be transmitted through resources that are allocated for the service specific identifier; and
transmitting the configuration information for the specific service to a terminal.

12. The method of claim 11, wherein the information for the specific service further comprises information about whether RBs other than the RB list is able to be multiplexed to the allocated resources.

13. The method of claim 11, wherein the specific service is served by semi-persistent scheduling.

14. The method of claim 13, wherein the SPS service is a voice over Internet protocol (VoIP) service.

15. A terminal comprising:
a wireless communication unit that receives uplink resource allocation information intended for a service specific identifier for a specific service and configuration information for the specific service comprising an RB list to be transmitted through resources that are allocated according to the uplink resource allocation information from a base station, and that transmits multiplexed data to the base station; and
a controller that multiplexes data of the RB list to the allocated resources.

16. The terminal of claim 15, wherein the configuration information for the specific service further comprises information representing whether data of RBs other than the RB list is able to be multiplexed to the allocated resources.

17. The terminal of claim 15, wherein the wireless communication unit further receives uplink resource allocation information intended for a C-RNTI from the base station, and
the controller multiplexes data of RBs other than the RB list to resources that are allocated for the C-RNTI according to a priority.

18. The terminal of claim 15, wherein the controller multiplexes, if multiplexing of data of RBs other than the RB list is allowed, the data of the RB list and the data of RBs other than the RB list to the allocated resources according to a priority, and multiplexes, if multiplexing of the data of RBs other than the RB list is not allowed, the data of the RB list to the allocated resources according to a priority.

19. The terminal of claim 18, further comprising a storage unit that stores data of the RB list and data of RBs other than the RB list.
